(19) United States
(12) Patent Application Publication
(10) Pub. No.: US 2025/0083636 A1
(43) Pub. Date: Mar. 13, 2025

(54) ANTI-THEFT DEVICE

(71) Applicant: Mark Allen Yerkes, Sanford, ME (US)

(72) Inventor: Mark Allen Yerkes, Sanford, ME (US)

(21) Appl. No.: 18/367,109

(22) Filed: Sep. 12, 2023

(51) Int. Cl. B60R 25/01; B60S 9/02; B60S 9/22

(52) U.S. Cl. CPC B60R 25/01; B60S 9/02; B60S 9/22

(57) ABSTRACT

An Anti-theft device molded from a single piece of heavy metal with a broad body and a pair of feet continuously molded from the main body, terminating at either ends of the main body and welded in the feet areas to provide maximum strength, to enable the device to support the heavy weight of large vehicles, trailers, and even an aircraft when the device is hooked up to the wheel axles of these heavy transportation systems. The anti-theft device can be used with any mobile transportation system encompassing, small to large vehicles such as, cars, large trailers, campers, recreational vehicles (RV's) and even aircraft when they require storage for a period of time in an open space, or even in a closed space where third parties can access those spaces to steal the systems.

### FIELD OF THE INVENTION

The present invention generally relates to anti-theft devices. More particularly, the invention relates to an antitheft device for use on a variety of transportation systems such as automobiles, motorbikes, campers, trailers, aircraft and other such mobile bodies routinely used in daily life.

### BACKGROUND OF THE INVENTION

Vehicle thefts are a growing concern all across the globe. Even a vehicle that is locked if parked in plain view is nevertheless subject to theft unless it is held in place through an antitheft system specific to the vehicle. The common antitheft devices available in the market are generally placed and locked into the steering wheels of the vehicles. Other mobile systems such as campers and trailers once dis-engaged from the main vehicle which is used to transport them, can be prevented from being stolen only by locking their wheels using anti-theft devices placed on their wheels. Once the wheels to these vehicles are removed as a means to prevent them from being stolen, they need a source of support at their bottom ends to hold them up while they are stationary. It is possible to hold up these vehicles using rudimentary means such as layers of bricks, metal posts etc. However, such supports do not also provide a means to prevent theft of the vehicles while in storage.

The present invention is an anti-theft device to prevent theft of a variety of mobile transportation systems especially while they are parked in an open space, prone to being stolen, without some means of protection from the theft.

### SUMMARY OF THE INVENTION

The present invention is an anti-theft device for use with mobile transportation systems encompassing, small to large vehicles such as, cars, large trailers, campers, recreational vehicles (RV's) and even aircraft when they require storage for a period of time in an open space, or even in a closed space where third parties can access those spaces to steal the systems.

It is an object of the present invention to provide an anti-theft device that is capable of bearing the weight of large vehicles such as recreational vehicles (RV's), trailers, campers and even tiny houses when the device is installed under these heavy structures.

It is another object of the anti-theft device of the present invention to increase the stability of heavy vehicles and other large structures while they are in storage for an extended period, by spreading their load over a broad area of the anti-theft device of the invention, thereby preventing the vehicles and structures from rolling to the side, or out of their storage area.

According to a preferred embodiment of the anti-theft device of the present invention, the body of the device is comprised of a metal plate of sufficient strength to support a large heavy vehicle such as a trailer, RV, camper, tiny house, and even an aircraft. In this embodiment of the anti-theft device of the invention, once the body of the trailer, RV, tiny house, or aircraft is lifted up by a jack device and the anti-theft device of the invention is secured to the wheel axle of these transportation systems, the weight of the structures are effectively held up by the body and feet of the anti-theft device.

In the exemplary embodiment of the anti-theft device of the present invention, the device is comprised of a substantially right-angled triangle-shaped main body constructed from a single molded piece of heavy metal such as steel, stainless steel, aluminum, carbon fiber etc. In this embodiment of the device, the main body plate of the device terminates at the two lower ends in L-shaped plates forming a pair of angular feet that are continuously molded from the same heavy metal as the body of the device and formed at the distal ends of the main body of the device with sufficient welding at the corners to provide added strength to the feet. In this embodiment of the anti-theft device of the invention, the feet of the device are formed perpendicular to the main body of the device which allows the heavy load of the body of the large vehicle or other structure to be spread laterally in conjunction with the main body of the device. The L-shaped plates of the feet are shaped in a manner to increase the bearing surface of the weight of the body of the large structure such as a trailer, or RV that is resting on the device. Increasing and lengthening the bearing surface of the load of the vehicle, reduces the likelihood of it rolling and sliding to the sides. In this embodiment of the device, the bottom of the feet are equipped with rubber pads to provide increased grip on paved surfaces.

In the exemplary embodiment of the anti-theft device of the invention, a nut and bolt arrangement is configured at the middle broad portion of the device to secure the device to the wheel axle of a vehicle, trailer or aircraft after these structures are suspended upward with a jack. A molded hub ring at the broad center of the heavy metal plate of the device holds a plurality of nuts and bolts and these along with a larger set of nuts and bolts surrounding the nut and bolt arrangement in the hub ring, fasten the device securely to the wheel axle of the heavy vehicle or other heavy structure. A set of embossed ribs on either side of the nut and bolt arrangements provide additional compressive strength to support the weight of heavy vehicles and other mobile large structures.

The preferred embodiment of the anti-theft device of the invention is additionally comprised of a one piece continuously molded upper arch and a one piece continuously molded lower arch forming a pair of upper and lower reinforcement bars to provide lateral reinforcement of the main body of the device. The channel-like construction of the reinforcement bars dramatically increases the load capacity of the main body of the device, and the tension of the reinforcement bars helps to hold the feet of the device securely to the ground. As the ground compacts or shifts under the weight of a large vehicle, or heavy structure such as an RV, trailer, tiny house, aircraft etc., the tension of the reinforcement bars draw the feet of the device together and automatically adjusts the feet so that they make constant contact with the ground.

The objects, embodiments and other features of the anti-theft device of the present invention disclosed in this summary of the invention will become more obvious to one skilled in the art when viewed in conjunction with the drawings and detailed description of the device accompanied by the appended claims.

### BRIEF DESCRIPTION OF THE DRAWINGS

FIG. 1 is a perspective view of the antitheft device of the present invention particularly showing the nut and bolt arrangement that is used to secure the device to the axle of a vehicle,

FIG. 2 is another perspective view of the antitheft device of the present invention showing the molded hub ring surrounded by the lug nut holes to contain the nut and bolt arrangement used to secure the device to the axle of a vehicle.

FIG. 3 is a side perspective view of the antitheft device of the present invention showing the molded hub ring surrounded by the lug nut holes to contain the nut and bolt arrangement used to secure the device to the wheel axle of a vehicle.

FIG. 4 is a perspective view of a pair of the antitheft device of the present invention installed on to the wheel axles of an automobile.

FIG. 5 is a perspective view of a single antitheft device of the present invention installed on to the wheel axle of a trailer.

FIG. 6 is a perspective view of the antitheft devices of the present invention installed on to the wheel axles of an aircraft.

### DETAILED DESCRIPTION OF THE INVENTION

The present invention is an anti-theft device molded from a single piece of heavy metal with a broad body and a pair of feet on either end of the body and welded in the feet areas to provide maximum strength to enable the device to support the heavy weight of large vehicles, trailers, and even an aircraft when the device is hooked up to the wheel axles of these heavy transportation systems.

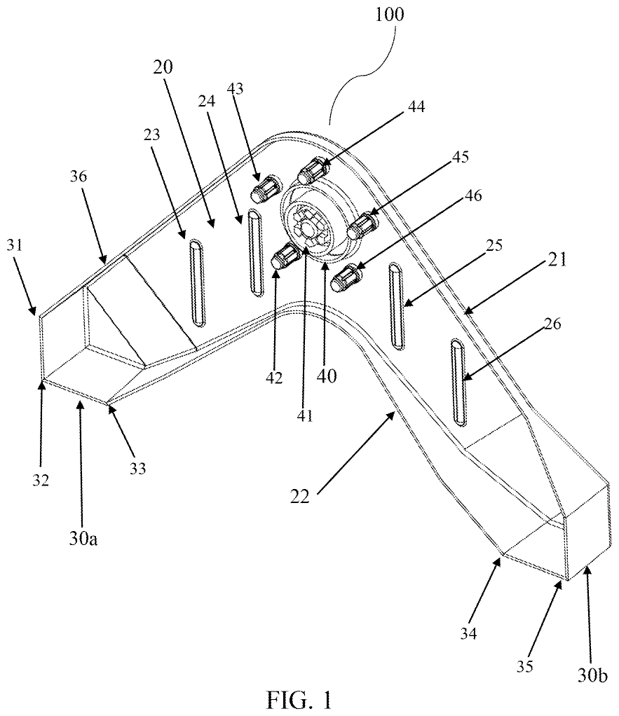

Referring now to the figures wherein like numerals represent like components in the several views presented and discussed, and more particularly referring to FIG. 1, the figure represents a perspective view of the anti-theft device 100 of the present invention. As seen in this perspective view of the anti-theft device 100 the device 100 is comprised of a main body plate 20 and a pair of pivotally mounted angular feet 30a and 30b constructed from a single molded piece of heavy metal such as steel, stainless steel, aluminum, carbon fiber or the like. In this embodiment of the device 100, the main body plate 20 terminates at the two lower ends in the pair of L-shaped angular feet 30a and 30b which are formed perpendicular to the main body plate 20 of the device 100 which allows the heavy load of the body of a large vehicle or other large and heavy structure to be spread laterally in conjunction with the main body of the device. To provide additional strength to bear the weight of heavy structures, the feet 30a and 30b are welded at their corners at 31, 32 and 33 as seen this view for feet 30a and welded corners 34 and 35 as seen in this view for feet 30b. A welded offset 36 is provided above each foot (seen here for the foot 30a), to center the heavy loads over the two feet. A reinforced molded hub ring 40 at the broad center and midpoint of the main body 20 holds a plurality of nuts and bolts 41 and these along with a larger set of nuts and bolts 42, 43, 44, 45 and 46 surrounding the nut and bolt arrangement 41 in the molded hub ring 40 help to fasten the anti-theft device 100 securely to the wheel axle of the heavy vehicle or other heavy structure. A set of embossed ribs 23, 24, 25, 26 placed on either side of the nut and bolt arrangements 41, 42, 43, 44, 45, 46 provide additional compressive strength to support the weight of heavy vehicles and other mobile large structures. To provide further compressive strength to hold up heavy vehicles and structures, the anti-theft device 100 is reinforced with a one piece continuously molded upper arch 21 and a one piece continuously molded lower arch 22 forming a pair of upper and lower reinforcement bars to provide lateral reinforcement of the main body of the anti-theft device 100. The channel-like construction of the reinforcement bars 21 and 22 dramatically increases the load capacity of the main body of the device 100 and the tension of the reinforcement bars 21 and 22 helps to hold the feet 30a and 30b of the device 100 securely to the ground. As the ground compacts or shifts under the weight of a large vehicle, or heavy structure such as an RV, trailer, tiny house, aircraft etc., the tension of the reinforcement bars 21 and 22 draw the feet 30a and 30b of the device 100 together and automatically adjusts the feet so that they make constant contact with the ground.

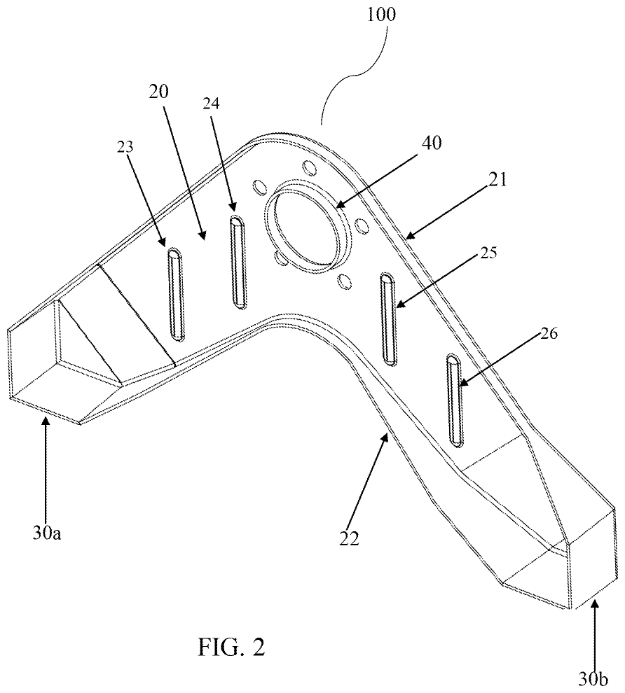

FIG. 2 is another perspective view of the antitheft device of the present invention showing the molded hub ring 40 surrounded by lug nut holes that hold the larger nut and bolt arrangement used to secure the Anti-theft device 100 to the wheel axle of a vehicle or large heavy structure. This view also shows the feet 30a and 30b, the main body 20, the set of embossed ribs 23, 24, 25, 26 on the main body 20 and the reinforcement bars 21 and 22.

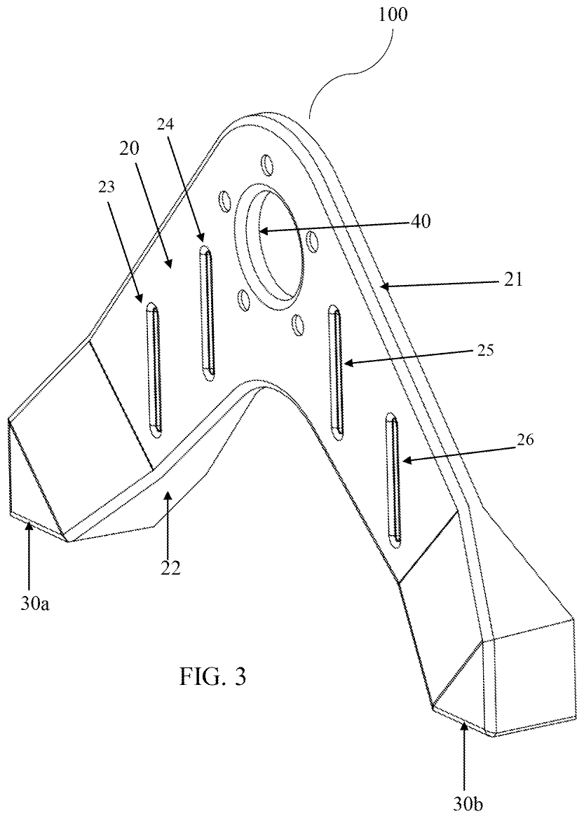

FIG. 3 is a side perspective view of the antitheft device 100 of the present invention showing the molded hub ring 40 surrounded by the lug nut holes to contain the nut and bolt arrangement used to secure the device to the axle of a vehicle. This view also shows the feet 30a and 30b the main body 20, the set of embossed ribs 23, 24, 25, 26 on the main body 20 and the reinforcement bars 21 and 22.

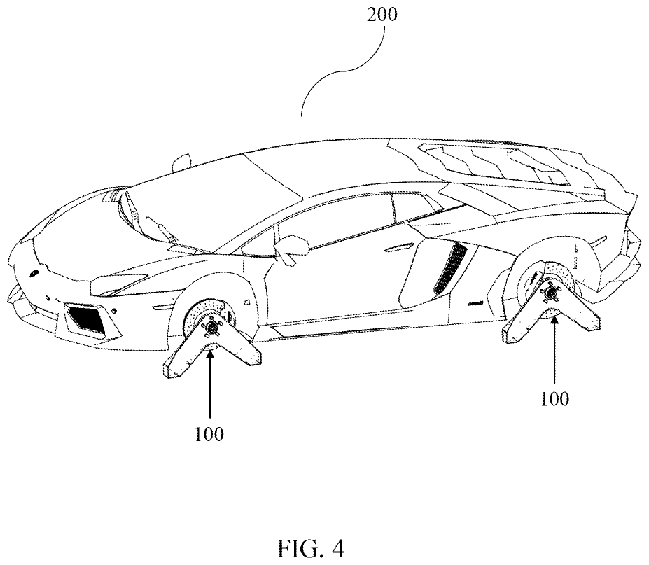

FIG. 4 is a perspective view of a pair of the antitheft device 100 of the present invention installed on to the front and back wheel axles of an automobile 200. A second pair of the anti-theft device 100 would be installed on the wheel axles on the opposite side of the automobile, not seen in this view.

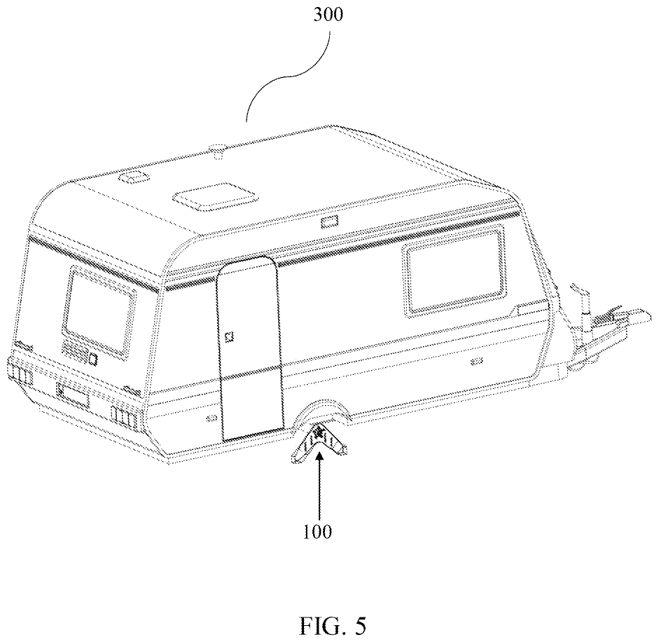

FIG. 5 is a perspective view of an antitheft device 100 of the present invention installed on to the wheel axle of a trailer 300 to hold the trailer in place where it is stored and prevent it from being stolen. If the trailer has a wheel on the opposite side, not shown in this figure, a second anti-theft device 100 of the invention will be installed on to the axle of that wheel, so that the trailer is balanced to prevent it from tilting and rolling over to the side.

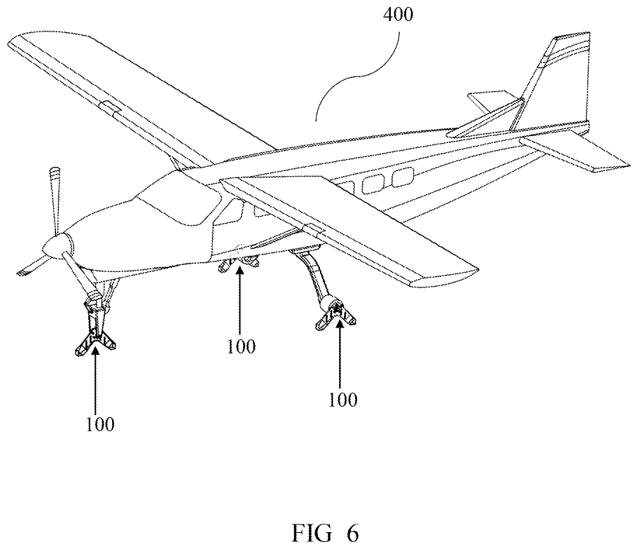

FIG. 6 is a perspective view of the antitheft device 100 of the present invention installed on to the wheel axles of an aircraft 400 to prevent it from being stolen while parked on the runway or in a hanger.

1. An anti-theft device comprising;
a main body with a pair of feet at distal ends of said main body;
said main body and said pair of feet continuously molded from a single piece of heavy metal;
said pair of feet L-shaped and formed perpendicular to said main body of said antitheft device;
said main body and said pair of feet together forming a single substantially right-angled triangle-shaped structure of said anti-theft device;
a molded hub ring at a broad center and midpoint of said main body;
a plurality of nuts and bolts within said molded hub ring;
a plurality of lug nut holes surrounding said molded hub ring holding a plurality of large nuts and bolts; and
said plurality of nuts and bolts within said molded hub ring and said plurality of large nuts and bolts held within said lug nut holes surrounding said molded hub ring, secure a wheel axle of a heavy vehicle to said main body of said anti-theft device.

2. The anti-theft device of claim 1 wherein, the pair of feet of the anti-theft device are welded at their three corners to provide additional strength to the feet to bear the load of heavy vehicles.

3. The anti-theft device of claim 1 wherein, a welded offset is provided above each foot to center heavy vehicles over the two feet.

4. The anti-theft device of claim 1 wherein, a set of embossed ribs on either side of the molded hub ring provide additional compressive strength to support the weight of heavy vehicles.

5. (canceled)

6. The anti-theft device of claim 1 wherein, the bottom of the feet are equipped with rubber pads to provide increased grip on paved surfaces where the heavy vehicles are stored.

7. The antitheft device of claim 1 wherein, the main body of the device has a one piece continuously molded upper arch and a one piece continuously molded lower arch forming a pair of upper and lower reinforcement bars having channel-like construction that provide lateral reinforcement for the main body of the device

8. The antitheft device of claim 1 wherein, the L-shape of the feet, and their formation perpendicular to the main body of the device allows the heavy load of the body of large vehicles resting on the device to spread laterally in conjunction with the main body of the device which reduces the likelihood of the vehicles rolling and sliding to the side.
